(19) United States
(12) Patent Application Publication
(10) Pub. No.: US 2026/0055304 A1
(43) Pub. Date: Feb. 26, 2026

(54) SELF-PRIMING OPTICALLY CLEAR ADHESIVES

(71) Applicant: 3M INNOVATIVE PROPERTIES COMPAN, St. Paul, MN (US)

(72) Inventors: Ryan J. Eismin, St. Paul, MN (US); David T. Amos, St. Paul, MN (US)

(21) Appl. No.: 19/102,538

(22) PCT Filed: Sep. 20, 2023
(86) PCT No.: PCT/IB2023/059309

§ 371 Date: Feb. 10, 2025

Related U.S. Application Data
(60) Provisional application No. 63/410,288, filed on Sep. 27, 2022.

(51) Int. Cl. C09J 7/38; C09J 5/00

(52) U.S. Cl. CPC C09J 7/385; C09J 5/00; C09J 2301/302; C09J 2301/408; C09J 2433/003; C09J 2467/00

(57) ABSTRACT

Self-priming adhesive articles include a release liner with a release surface, an adhesion promotion layer on the release surface, and an optically clear adhesive layer in contact with the adhesion promotion layer. The adhesion between the adhesive layer and the adhesion promotion layer is higher than that of the adhesion between the adhesion promotion layer and the release liner, such that the adhesion promotion layer remains adhered to the surface of the adhesive layer upon removal from the release liner. The adhesive articles can be prepared by applying the adhesion promotion layer to the release liner and applying the adhesive layer to the adhesion promotion layer, or by applying to the adhesion promotion layer to the surface of the adhesive layer and then contacting the adhesion promotion layer-coated adhesive layer to the release liner.

### SUMMARY

Disclosed herein are adhesive articles and methods for preparing the adhesive articles. In some embodiments, the adhesive articles comprise a release liner with a first major surface and a second major surface, where at least the second major surface comprises a release surface, an adhesion promotion layer with a first major surface and a second major surface, where the first major surface of the adhesion promotion layer is in contact with the second major surface of the release liner, and an optically clear adhesive layer with a first major surface and a second major surface, where the first major surface of the optically clear adhesive layer is in contact with the second major surface of the adhesion promotion layer. The adhesion between the optically clear adhesive layer and the adhesion promotion layer is higher than the adhesion between the adhesion promotion layer and the release liner, such that the adhesion promotion layer remains adhered to the surface of the optically clear adhesive layer upon removal of the optically clear adhesive layer from the release liner. The adhesion promotion layer, like the adhesive layer is optically clear. In some embodiments, the article further comprises an additional release liner or a substrate disposed on the optically clear adhesive layer.

Also disclosed are methods of preparing adhesive articles. In some embodiments the method comprises providing a release liner, where the release liner has a first major surface and a second major surface, and at least the second major surface comprises a release surface, providing an adhesion promotion composition, disposing the adhesion promotion composition on the second major surface of the release liner to form an adhesion promotion layer on the second major surface of the release liner, where the adhesion promotion layer has a first major surface in contact with the release surface of the release liner, and a second major surface, providing an optically clear adhesive or a precursor mixture capable of forming an optically clear adhesive, disposing the optically clear adhesive or precursor mixture on the second major surface of the adhesion promotion layer, to form an optically clear adhesive layer, with a first major surface and a second major surface, where the first major surface of the optically clear adhesive layer is in contact with the second major surface of the adhesion promotion layer. The adhesion between the optically clear adhesive layer and the adhesion promotion layer is higher than the adhesion between the adhesion promotion layer and the release liner, such that adhesion promotion layer remains adhered to the surface of the optically clear adhesive layer upon removal of the optically clear adhesive layer from the release liner.

In some embodiments, the method of preparing an adhesive article comprises providing a release liner, where the release liner has a first major surface and a second major surface, and where at least the second major surface comprises a release surface, providing an adhesion promotion composition, providing an optically clear adhesive layer with a first major surface and a second major surface, disposing the adhesion promotion composition on the first major surface of the optically clear adhesive layer to form an adhesion promotion layer on the first major surface of the optically clear adhesive layer, where the adhesion promotion layer has a second major surface in contact with the first major surface of the optically clear adhesive layer, and an exposed first major surface, disposing the optically clear adhesive layer with the adhesion promotion layer on the release surface of the release liner such that the first major surface of the adhesion promotion layer is in contact with the release surface of the release liner, The adhesion between the optically clear adhesive layer and the adhesion promotion layer is higher than the adhesion between the adhesion promotion layer and the release liner, such that adhesion promotion layer remains adhered to the surface of the optically clear adhesive layer upon removal of the optically clear adhesive layer from the release liner.

### BRIEF DESCRIPTION OF THE DRAWINGS

The present application may be more completely understood in consideration of the following detailed description of various embodiments of the disclosure in connection with the accompanying drawings.

FIG. 1 is a cross sectional view of an adhesive article of this disclosure.

### DETAILED DESCRIPTION

A wide range of optical articles are being developed for a wide range of uses. Among the optical articles are articles and devices that include multiple layers. Frequently these multiple layers are attached to each other with adhesive layers. Because the adhesive layers are in the optical pathway, the optical properties of the adhesive layers are an important consideration in the assembly of the optical articles.

Optically clear adhesives (hereinafter referred to as “OCA”) are widely used in a wide variety of articles and have increasingly stringent property requirements. Not only do these adhesives have to have desirable optical properties and maintain these properties in a variety of environmental conditions, but they also have to fulfill the role of an adhesive namely, to adhere together two substituents. In many instances, the OCA is a pressure sensitive adhesive, in other instances the OCA is a heat-activated adhesive.

The requirements for optical articles are becoming more demanding. For example, many optical articles have increasingly complex shapes and also are meant to bend, and therefore adhesives that have flexibility and adhere to variously shaped surfaces are needed for these uses. Variously shaped surfaces include a wide range of non-planar surfaces.

Dual-sided tapes, also called “transfer tapes” are adhesive tapes that have adhesive on both exposed surfaces. In some transfer tapes, the exposed surfaces are simply the two surfaces of a single adhesive layer. Typically, transfer tapes are supplied laminated to at least one release liner, or between two release liners. An advantage of transfer tapes is that they can be used to form a wide range of adhesive articles. The transfer tape can be laminated to a backing or film layer to form a tape and this tape can then be further laminated to another surface. A particularly useful use for transfer tapes is the lamination together of two substrates by laminating to one substrate, removing the release liner from the non-laminated adhesive surface and disposing a second substrate to the exposed adhesive surface.

Because a wide range of substrates or films are used in optical articles and devices, it can often be difficult for a single adhesive to adhere to the wide range of substrates or films. This is complicated by the fact that the substrates or films can have a range of shapes or configurations as well, and may be designed to be flexible, such as being bendable, and the adhesive needs to not only adhere to these surfaces but also retain the desired optical properties.

One method for increasing the adhesion of an adhesive layer to a substrate surface is to pre-treat the substrate surface with a primer layer. Primers are well known in the coating arts as a relatively thin layer applied to a surface to change the surface chemistry to make the surface more susceptible to adhesion. A drawback to the use of primer layers is that the use of primers adds an additional step to the assembly of the device. Additionally, often primers are supplied in a solvent, either an organic solvent or water, and therefore a drying step is also required. This can be problematic in an article assembly facility, as coating and drying of primer layers requires special equipment and precautions. This is especially true if solvent-borne primers are used, and drying is required.

In this disclosure a method of priming is described in which a primer layer is applied to the surface of an OCA. In many embodiments, the primer is applied to a release liner surface, the OCA is disposed on the release liner with the primer on its surface, such that upon removal of the OCA from the release liner at least some of the primer is transferred to the OCA surface. In this way, when the OCA is applied to a surface, the primer is applied as well. In other embodiments, the primer layer is disposed on the surface of the OCA prior to the OCA being disposed on the release liner.

There are a number of advantages of this methodology. In this way, a primer can be delivered to a surface without requiring an additional priming step. Additionally, as was mentioned above, the difficulties of applying a primer in an assembly facility are avoided, since the primer is applied when the article is formed and therefore is in a facility that has the equipment and expertise to safely carry out the application and/or drying of a primer layer.

The term “adhesive” as used herein refers to polymeric compositions useful to adhere together two adherends. Examples of adhesives are pressure sensitive adhesives and heat-activated adhesives.

Pressure sensitive adhesive compositions are well known to those of ordinary skill in the art to possess properties including the following: (1) aggressive and permanent tack, (2) adherence with no more than finger pressure, (3) sufficient ability to hold onto an adherend, and (4) sufficient cohesive strength to be cleanly removable from the adherend. Materials that have been found to function well as pressure sensitive adhesives are polymers designed and formulated to exhibit the requisite viscoelastic properties resulting in a desired balance of tack, peel adhesion, and shear holding power. Obtaining the proper balance of properties is not a simple process.

Heat-activated adhesives are non-tacky at room temperature but become tacky and capable of bonding to a substrate at elevated temperatures. These adhesives usually have a T_{g} (glass transition temperature) or melting point (Tₘ) above room temperature. When the temperature is elevated above the T_{g} or Tₘ, the storage modulus usually decreases, and the adhesive becomes tacky.

As used herein the term “self-priming” refers to an adhesive layer that has a continuous or discontinuous layer of an adhesion promoting material on at least one adhesive surface. The adhesion promoting material promotes the adhesion of adhesive layer to a substrate surface such that the adhesion of the adhesive layer is increased relative to the adhesion of the adhesive layer itself without the adhesion promoting material, and where the substrate surface has not had a primer or adhesion promotion material applied to it.

The term “(meth)acrylate-based” refers to polymers that contain at least a majority of (meth)acrylate monomers. The term “(meth)acrylate” refers to monomeric acrylic or methacrylic esters of alcohols. Acrylate and methacrylate monomers or oligomers are referred to collectively herein as “(meth)acrylates”.

The terms “siloxane-based” as used herein refer to polymers or units of polymers that contain siloxane units. The terms silicone or siloxane are used interchangeably and refer to units with dialkyl or diaryl siloxane (—SiR₂O—) repeating units.

The terms “room temperature” and “ambient temperature” are used interchangeably to mean temperatures in the range of 20° C. to 25° C.

The terms “polymer” and “macromolecule” are used herein consistent with their common usage in chemistry. Polymers and macromolecules are composed of many repeated subunits. As used herein, the term “macromolecule” is used to describe a group attached to a monomer that has multiple repeating units. The term “polymer” is used to describe the resultant material formed from a polymerization reaction.

The term “alkyl” refers to a monovalent group that is a radical of an alkane, which is a saturated hydrocarbon. The alkyl can be linear, branched, cyclic, or combinations thereof and typically has 1 to 20 carbon atoms. In some embodiments, the alkyl group contains 1 to 18, 1 to 12, 1 to 10, 1 to 8, 1 to 6, or 1 to 4 carbon atoms. Examples of alkyl groups include, but are not limited to, methyl, ethyl, n-propyl, isopropyl, n-butyl, isobutyl, tert-butyl, n-pentyl, n-hexyl, cyclohexyl, n-heptyl, n-octyl, and ethylhexyl.

Unless otherwise indicated, the terms “optically transparent”, and “visible light transmissive” are used interchangeably, and refer to an article, film or adhesive that has a high light transmittance over at least a portion of the visible light spectrum (about 400 to about 700 nm). Typically, optically transparent articles have a visible light transmittance of at least 90% and a haze of less than 10%.

Unless otherwise indicated, “optically clear” refers to an adhesive or article that has a high light transmittance over at least a portion of the visible light spectrum (about 400 to about 700 nm), and that exhibits low haze, typically less than about 5%, or even less than about 2%. In some embodiments, optically clear articles exhibit a haze of less than 1% at a thickness of 50 micrometers or even 0.5% at a thickness of 50 micrometers. Typically, optically clear articles have a visible light transmittance of at least 95%, often higher such as 97%, 98% or even 99% or higher.

Disclosed herein are adhesive articles. The articles are disposed on a release liner. The adhesive articles may be transfer tapes, with an adhesive layer disposed on a release liner or between two release liners, or they may be tape articles with an adhesive layer and a substrate.

In some embodiments, the adhesive article comprise a release liner with a first major surface and a second major surface, where at least the second major surface comprises a release surface, an adhesion promotion layer with a first major surface and a second major surface, wherein the first major surface is in contact with the second major surface of the release liner, and an optically clear adhesive layer with a first major surface and a second major surface, where the first major surface of the optically clear adhesive layer is in contact with the second major surface of the adhesion promotion layer. The adhesion between the optically clear adhesive layer and the adhesion promotion layer is higher than the adhesion between the adhesion promotion layer and the release liner. This means that the adhesion promotion layer remains adhered to the surface of the optically clear adhesive layer upon removal of the optically clear adhesive layer from the release liner. The adhesion promotion layer, like the adhesive layer, is optically clear. In many embodiments, the optically clear adhesive layer is a pressure sensitive adhesive, in some embodiments, the optically clear adhesive layer is a heat-activated adhesive.

The adhesive articles comprise a release liner. Release liners are well understood in the adhesive arts as being film or sheet articles that have at least one surface that is adhesive, meaning a surface to which adhesives do not strongly adhere. Typical release liners include those prepared from paper (e.g., Kraft paper) or polymeric material (e.g., polyolefins such as polyethylene or polypropylene, ethylene vinyl acetate, polyurethanes, polyesters such as polyethylene terephthalate, and the like, and combinations thereof). At least some release liners are coated with a layer of a release agent such as a silicone, a fluorosilicone-containing material or a fluorocarbon-containing material. Exemplary release liners include, but are not limited to, liners commercially available from CP Film (Martinsville, Va.) under the trade designation “T-30” and “T-10” that have a silicone release coating on polyethylene terephthalate film. Particularly suitable are the silicone-coated PET release liners available from SKC Haas as RF32N and RF02N.

The adhesive articles also comprise an optically clear adhesive (OCA). The OCA may be a pressure sensitive adhesive or a heat-activated adhesive. Examples of suitable OCAs include (meth)acrylate pressure sensitive adhesives, (meth)acrylate-based pressure sensitive adhesives, polyolefin pressure sensitive adhesives, polyurethane pressure sensitive adhesives, siloxane-based pressure sensitive adhesives, polyvinyl butyral heat-activated adhesives, or a combination thereof. The pressure sensitive adhesive comprises at least one polymeric component and may additionally comprise additional components such a tackifying resins, plasticizing resins, and the like as long as the additives do not interfere with the optical properties of the adhesive composition.

Each of these classes of polymeric pressure sensitive adhesives are well understood in the adhesive arts. Polyolefin pressure sensitive adhesives, also called a poly(1-alkene) pressure sensitive adhesives, are polymers or co-polymers prepared from olefin monomers. The polymers may also include radiation activatable functional groups grafted thereon as described in U.S. Pat. No. 5,209,971 (Babu, et al). Polyurethane pressure sensitive adhesives useful in the disclosure include, for example, those disclosed in U.S. Pat. No. 3,718,712 (Tushaus); U.S. Pat. No. 3,437,622 (Dahl); and U.S. Pat. No. 5,591,820 (Kydonieus et al.).

In some embodiments, the pressure sensitive adhesive comprises a (meth)acrylate pressure sensitive adhesive or a (meth)acrylate-based pressure adhesive comprising: one or more alkyl (meth)acrylate monomers with 2-18 carbon atoms and may contain one or more hydroxyl groups; and at least one reinforcing monomer. Such pressure sensitive adhesives generally have a glass transition temperature of about −20° C. or less. Examples of suitable alkyl (meth)acrylate monomers include for example, isooctyl acrylate, 2-ethyl-hexyl acrylate, n-butyl acrylate, HEA (hydroxyl ethyl acrylate), and HEMA (hydroxyl ethyl methacrylate). Examples or reinforcing monomers include, for example, (meth)acrylic acid, (meth)acrylamide, ethylene vinyl acetate, N-vinyl pyrrolidone and styrene macromers.

Silicone pressure sensitive adhesives typically comprise two major components, a polymer or gum, and a tackifying resin. The polymer is typically a high molecular weight polydimethylsiloxane or polydimethyldiphenylsiloxane, that contains residual silanol functionality (SiOH) on the ends of the polymer chain, or a block copolymer comprising polydiorganosiloxane soft segments and urea or oxamide terminated hard segments. The tackifying resin is generally a three-dimensional silicate structure that is endcapped with trimethylsiloxy groups (OSiMe₃) and also contains some residual silanol functionality. Examples of tackifying resins include SR 545, from General Electric Co., Silicone Resins Division, Waterford, N.Y., and MQD-32-2 from Shin-Etsu Silicones of America, Inc., Torrance, Calif. Manufacture of typical silicone pressure sensitive adhesives is described in U.S. Pat. No. 2,736,721 (Dexter). Manufacture of silicone urea block copolymer pressure sensitive adhesive is described in U.S. Pat. No. 5,214,119 (Leir, et al). Other materials can be added for special purposes, including pigments, plasticizers, and fillers. Fillers are typically used in amounts from 0 parts to 10 parts per 100 parts of silicone pressure sensitive adhesive. Examples of fillers that can be used include zinc oxide, silica, carbon black, pigments, metal powders and calcium carbonate. One particularly suitable class or siloxane-containing pressure sensitive adhesives are those with oxamide terminated hard segments such as those described in U.S. Pat. No. 7,981,995 (Hays) and U.S. Pat. No. 7,371,464 (Sherman).

In some embodiments, the adhesive layer is at least partially formed of polyvinyl butyral. The polyvinyl butyral layer may be formed via known aqueous or solvent-based acetalization process in which polyvinyl alcohol is reacted with butyraldehyde in the presence of an acidic catalyst. In some instances, the polyvinyl butyral layer may include or be formed from polyvinyl butyral that is commercially available from Solutia Incorporated, of St. Louis, MO, under the trade name “BUTVAR” resin.

In some instances, the polyvinyl butyral layer may be produced by mixing resin and (optionally) plasticizer and extruding the mixed formulation through a sheet die. If a plasticizer is included, the polyvinyl butyral resin may include about 20 to 80 or perhaps about 25 to 60 parts of plasticizer per hundred parts of resin. Examples of suitable plasticizers include esters of a polybasic acid or a polyhydric alcohol. Suitable plasticizers are triethylene glycol bis(2-ethylbutyrate), triethylene glycol di-(2-ethylhexanoate), triethylene glycol diheptanoate, tetraethylene glycol diheptanoate, dihexyl adipate, dioctyl adipate, hexyl cyclohexyl adipate, mixtures of heptyl and nonyl adipates, diisononyl adipate, heptylnonyl adipate, dibutyl sebacate, polymeric plasticizers such as the oil-modified sebacic alkyds, and mixtures of phosphates and adipates such as disclosed in U.S. Pat. No. 3,841,890 and adipates such as disclosed in U.S. Pat. No. 4,144,217.

The adhesive article also comprises an adhesion promotion layer. A wide variety of adhesion promotion agents are suitable. Generally, the adhesion promotion agents comprise materials that are commonly referred to as “primers” or “adhesion promoters”. Primers and adhesion promoters are materials that are applied as thin coatings on a surface and strongly adhere to the surface and provide a modified surface chemistry to the surface. In some embodiments, the adhesion promotion agent comprises polyamides, poly(meth)acrylates, chlorinated polyolefins, rubbers, chlorinated rubbers, polyurethanes, siloxanes, silanes, polyester, epoxies, polycarbodiimides, phenolics, and combinations thereof.

Typically, these agents are solvent-based, meaning that they are supplied in a solvent such as an organic solvent or water. Solvent-based primer compositions comprise the base polymer admixed with a solvent. The solvent may be a single solvent or a blend of solvents. The solvent-based primer composition generally contains about 5 to about 60 parts by weight of the base polymer, more typically about 10 to about 40 parts base polymer or even about 10 to about 30 parts base polymer, with the remainder of the primer composition being solvent and optional additives.

Among the particularly suitable film forming resins are acrylic resins, polyvinyl resins and mixtures thereof. Various acrylic resins are know. In general, acrylic resins are prepared from various (meth)acrylate monomers such as polymethylmethacrylate (PMMA), methyl methacrylate (MMA), ethyl acrylate (EA), butyl acrylate (BA), butyl methacrylate (BMA), n-butyl methacrylate (n-BMA) isobutylmethacrylate (IBMA), polyethylmethacrylate (PEMA), etc. alone or in combination with each other. Exemplary acrylic resins include those commercially available from Rohm and Haas, Co., Philadelphia, Pa. under the trade designation “PARALOID” and from Ineos Acrylics, Cordova, Tenn. under the trade designation “ELVACITE” resins. Other suitable polyacrylic materials include those from S. C. Johnson, Racine, Wis. under the trade designation “JONCRYL” acrylics. Polyvinyl resins include vinyl chloride/vinyl acetate copolymers, such as available from Rohm and Haas, Co., Philadelphia, Pa. under the trade designation “ACRYLOID” and from available from Union Carbide Corp., a subsidiary of The Dow Chemical Company (“Dow”), Midland Mich. under the trade designation “VYHH” as well as vinyl chloride/vinyl acetate/vinyl alcohol terpolymers also commercially available from Union Carbide Corp. under the trade designation “UCAR VAGH”. Other polyvinyl chloride resins are available from Occidental Chemical, Los Angeles, Calif.; BF Goodrich Performance Materials, Cleveland, Ohio; and BASF, Mount Olive, NJ.

Suitable water-based primers are generally emulsions or dispersions that are substantially free of water-soluble base polymers as a major component. Water-based emulsions and dispersions are advantageous to reduce solvent emissions by employing primer compositions that are substantially free of volatile organic solvents. An exemplary water-based primer includes a crosslinked poly(meth)acrylate polymer such as a butyl acrylate/methyl methacrylate copolymer crosslinked with a sulfo-urethane-silanol polymer.

In some embodiments, the coating comprises a poly(meth)acrylate-based polymer, a urethane-based polymer, a siloxane-based polymer or a combination thereof.

Exemplary urethane-based polymers include the polyurethane NEO-REZ available from DSM.

Exemplary siloxanes include those described in U.S. Pat. No. 5,866,222 (Seth et al.) and pending U.S. Patent Application Ser. No. 61/579,115 filed on Dec. 22, 2011, titled “Adhesive Article Including Primer Layer and Method of Making the Same”. U.S. Pat. No. 5,866,222 describes the modification of release coatings to give non-tacky coatings with higher release values to, for example, block copolymer-based pressure sensitive adhesives, through the use of 1 to 30 weight percent of MQ tackifying resin. Higher release values means that the pressure sensitive adhesive has a greater adhesion to the coating than to non-modified release coating. Pending U.S. Patent Application Ser. No. 61/579,115 describes adhesive articles that include a siloxane adhesive and a substrate, with a primer layer interposed between the siloxane adhesive and the substrate. The primer layer includes a siloxane polyoxamide.

A number of (meth)acrylate-based primers are suitable. Besides the primers described above, a particularly suitable primer is the commercially available solventborne material “3M Adhesion Promoter 2262AT” available from 3M Company, St. Paul, MN.

Particularly suitable adhesion promotion agents include Universal Primer 94 from 3M Company and the (meth)acrylate-based primer prepared in the Examples section and described as APA-2.

In some embodiments, the adhesive article further comprises a substrate in contact with the second major surface of the optically clear adhesive layer. A wide variety of substrates are suitable. Examples of suitable substrates include release liners, tape backings, and optical films. Release liners are described above. The substrate may be the same release liner as the one on which the adhesive article is disposed, or it may be different.

A wide variety of tape backings are suitable. Tape backings are well understood in the adhesive art and may comprise materials such as polymeric films, especially films of polyolefin, polyester, polyurethane, and the like. Other conventional tape backings include webs, such as woven and non-woven webs, fabrics, foams, and the like. Since the adhesive articles are generally optically clear, often the tape backing likewise is optically clear, and is selected to have this property.

A wide range of optical films are suitable. In some embodiments, the optical film comprises a single-layer optical film. In other embodiments, the optical film comprises a multi-layer optical film.

As used herein, the term “optical film” refers to a film that can be used to produce an optical effect. The optical films are typically polymer-containing films that can be a single layer or multiple layers. The optical films are flexible and can be of any suitable thickness. The optical films often are at least partially transmissive, reflective, antireflective, polarizing, optically clear, or diffusive with respect to some wavelengths of the electromagnetic spectrum (e.g., wavelengths in the visible, ultraviolet, or infrared regions of the electromagnetic spectrum). Exemplary optical films include, but are not limited to, visible mirror films, color mirror films, solar reflective films, collimating films, ultraviolet reflective films, brightness enhancement films, reflective polarizer films such as dual brightness enhancement films, absorptive polarizer films, optically clear films, tinted films, and antireflective films.

Some optical films have multiple layers such as multiple layers of polymer-containing materials (e.g., polymers with or without dyes) or multiple layers of metal-containing material and polymeric materials. Some optical films have alternating layers of polymeric material with different indexes of refraction. Other optical films have alternating polymeric layers and metal-containing layers. Exemplary optical films are described in the following patents: U.S. Pat. No. 6,049,419 (Wheatley et al.); U.S. Pat. No. 5,223,465 (Wheatley et al.); U.S. Pat. No. 5,882,774 (Jonza et al.); U.S. Pat. No. 6,049,419 (Wheatley et al.); U.S. Pat. No. RE 34,605 (Schrenk et al.); U.S. Pat. No. 5,579,162 (Bjornard et al.); and U.S. Pat. No. 5,360,659 (Arends et al.).

The adhesive articles of this disclosure can have a wide range of thicknesses. Since the adhesion promoter layer is very thin relative to the thickness of the optically clear adhesive layer, the total thickness of the adhesive article is essentially the same as the thickness of the optically clear adhesive layer. In some embodiments, the optically clear adhesive layer has a thickness of from 1 micrometer to 1 millimeter. In some embodiments the optically clear adhesive layer has a thickness of at least 25 micrometers (1 mil), at least 51 micrometers (2 mils), or even at least 102 micrometers (4 mils). In some embodiments the optically clear adhesive layer has a thickness of less than 0.9 millimeters, 0.75 millimeters, or even less than 0.5 millimeters.

The adhesive articles of this disclosure have a wide range of desirable properties. As mentioned above, typically the adhesive articles are optically clear. Also as mentioned above, the presence of the adhesion promotion layer provides for increased adhesion by the adhesive layer. As will be discussed in greater detail below, the adhesion promoter layer can be prepared in two different ways. In many embodiments, the adhesion promotion layer is prepared by disposing on the second major surface of the release liner an adhesion promotion material as a solution, emulsion or dispersion and drying to remove the solvent. In other embodiments, the adhesion promotion layer is prepared by disposing on the first major surface of the optically clear adhesive layer an adhesion promotion material as a solution, emulsion or dispersion and drying to remove the solvent.

The adhesion promotion layer, as the name suggests, increases the adhesion of the optically clear adhesive layer to a substrate surface, such that when the adhesion promotion layer surface is contacted to a substrate surface, the adhesion is greater than the adhesion of an identical article without the adhesion promotion layer.

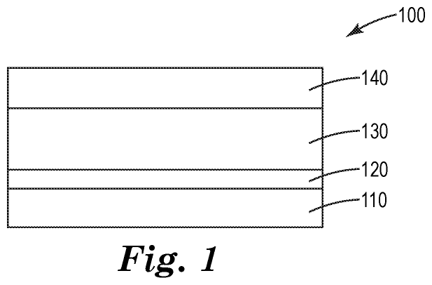

An example of an article of this disclosure is shown in FIG. 1, where article 100 comprises first release liner 110, primer layer 120 disposed between the first release liner 110 and adhesive layer 130. Optional second release liner 140 is disposed on the adhesive layer 130.

Also disclosed herein are methods for preparing adhesive articles, where the adhesive articles are self-priming. Two different methods are disclosed. In the first method, an adhesion promotion material is applied to a release liner surface, an adhesive layer is contacted to the adhesion promotion material, and when removed from the liner the adhesion promotion material adheres to the adhesive layer. In the second method, the adhesion promotion material is applied to the adhesive surface of an adhesive layer and then the adhesive layer is contacted to the surface of a release liner.

In some embodiments, the first method for preparing an adhesive article comprises providing a release liner with a first major surface and a second major surface, where at least the second major surface comprises a release surface, providing an adhesion promotion composition, disposing the adhesion promotion composition on the second major surface of the release liner to form an adhesion promotion layer on the second major surface of the release liner. The adhesion promotion layer has a first major surface in contact with the release surface of the release liner, and a second major surface. The method further comprises providing an optically clear adhesive or a precursor mixture capable of forming an optically clear adhesive, disposing the optically clear adhesive or precursor mixture on the second major surface of the adhesion promotion layer, to form an optically clear pressure sensitive adhesive layer. The optically clear adhesive layer may be a pressure sensitive adhesive layer or a heat-activated adhesive layer and has a first major surface and a second major surface, wherein the first major surface of the optically clear adhesive layer is in contact with the second major surface of the adhesion promotion layer. The adhesion between the optically clear adhesive layer and the adhesion promotion layer is higher than the adhesion between the adhesion promotion layer and the release liner, such that adhesion promotion layer remains adhered to the surface of the optically clear adhesive layer upon removal of the optically clear adhesive layer from the release liner.

In some embodiments, disposing the adhesion promotion composition on the second major surface of the release liner comprises coating a solution, emulsion or dispersion of an adhesion promoting material, and drying the coating. Suitable adhesion promoting materials are described above and include polyamides, poly(meth)acrylates, chlorinated polyolefins, rubbers, chlorinated rubbers, polyurethanes, siloxanes, silanes, polyester, epoxies, polycarbodiimides, phenolics, and combinations thereof.

The optically clear adhesive layer is a pressure sensitive adhesive, or a heat activated adhesive. The adhesives are described above and are selected from a (meth)acrylate pressure sensitive adhesive, a (meth)acrylate-based pressure sensitive adhesive, a polyolefin pressure sensitive adhesive, a polyurethane pressure sensitive adhesive, a siloxane-based pressure sensitive adhesive, a polyvinyl butyral heat-activated adhesive, or a combination thereof.

Examples of an adhesive precursor mixture that can be applied to the adhesion promoting layer to form an optically clear pressure sensitive adhesive layer includes a precursor mixture of a coatable (meth)acrylate-based syrup and a photoinitiator. After disposing the coatable (meth)acrylate syrup onto the adhesion promoting layer present on the second surface of the release liner, the precursor mixture is irradiated to cure the precursor mixture and form the adhesive layer. This process of preparing a monomer mixture, partially pre-polymerizing the monomer mixture to form a coatable syrup is described in, for example, U.S. Pat. No. 6,339,111 (Moon, et al.).

In some embodiments, the method may further comprise disposing a substrate on the second major surface of the optically clear pressure sensitive adhesive layer. Suitable substrates are described above, and may comprise a release liner, a tape backing, or an optical film.

The formed adhesive articles have an optically clear adhesive layer with a thickness of 1 micrometer to 1 millimeter. The adhesive articles have the desirable adhesive properties described above. Among these properties are the increased adhesion of the articles with the adhesion promotion layer to a substrate surface is greater than an identical adhesive article without the adhesion promotion layer.

In some embodiments, the second method for preparing an adhesive article comprises providing a release liner, with a first major surface and a second major surface, where at least the second major surface comprises a release surface. The method further comprises providing an adhesion promotion composition, providing an optically clear adhesive layer with a first major surface and a second major surface, disposing the adhesion promotion composition on the first major surface of the optically clear adhesive layer to form an adhesion promotion layer on the first major surface of the optically clear adhesive layer, where the adhesion promotion layer has a second major surface in contact with the first major surface of the optically clear adhesive layer, and an exposed first major surface. The optically clear adhesive layer with the adhesion promotion layer on its surface is contacted to the release surface of the release liner such that the first major surface of the adhesion promotion layer is in contact with the release surface of the release liner. The adhesion between the optically clear adhesive layer and the adhesion promotion layer is higher than the adhesion between the adhesion promotion layer and the release liner, such that adhesion promotion layer remains adhered to the surface of the optically clear adhesive layer upon removal of the optically clear adhesive layer from the release liner. The elements of the adhesive article are described above.

### Examples

These examples are merely for illustrative purposes only and are not meant to be limiting on the scope of the appended claims. The following abbreviations are used: cm=centimeters; N=Newtons. The terms “weight %”, “% by weight”, and “wt %” are used interchangeably.

These examples are merely for illustrative purposes only and are not meant to be limiting on the scope of the appended claims.

Table of Abbreviations

| Abbreviation | |
|---|---|
| or Trade | |
| Designation | Description |
| Release | Polyethylene terephthalate liner with a thickness of 76 |
| Liner-1 | micrometer thickness (3 mils) with a silicone coating, |
| | commercially available from SKC Haas as RF32N |
| Release | Polyethylene terephthalate liner with a thickness of 51 |
| Liner-2 | micrometer thickness (2 mils) with a silicone coating, |
| | commercially available from SKC Haas as RF02N |
| Adhesive-1 | Commercially available as OCA 8146-2 from 3M Company |
| Adhesive-2 | Commercially available as CEF3502 from 3M Company |
| APA-1 | Adhesion Promoting Agent-1 commercially available as |
| | Universal Primer 94 from 3M Company |
| APA-2 | Adhesion Promoting Agent-2, (meth)acrylate-based primer |
| | solution prepared as described in Synthesis Example 1. |

### Test Methods

### 180° Peel Adhesion

This peel adhesion test is similar to the test method described in ASTM D 3330-90, substituting a glass substrate for the stainless steel substrate described in the test.

Adhesive samples were laminated to 51 micrometer thick (2 mil) polyethylene terephthalate films and were cut into 1.0 centimeter by 15 centimeter strips. Each strip was then adhered to a 10 centimeter by 20 centimeter clean, solvent washed glass coupon using a 2-kilogram roller passed once over the strip. The bonded assembly dwelled at room temperature for about 20 minutes or for 3 days and was tested for 180° peel adhesion using an IMASS slip/peel tester (Model 3M90, commercially available from Instrumentors Inc., Strongsville, OH) at a rate of 15 centimeters/minute (6 inches/minute) over a five second data collection time. Two samples were tested; the reported peel adhesion value is an average of the peel adhesion value from each of the two samples.

### EXAMPLES

### Synthesis Example 1: Preparation of Adhesion Promotion Agent-2

The acrylate polymer for APA-2 was prepared by combining 53.2 grams of iso-octyl acrylate, 53.2 grams of methyl methacrylate (Dow Chemical), 20.3 g of acrylic acid (Dow Chemical) and 126.6 grams of ethyl acetate. 1.0 grams of thermal initiator (VAZO-67 from Chemours) was added and the solution was deoxygenated for 2 minutes with nitrogen. After heating at 65° C. for 47 hours, a solution was obtained that was determined to have a 50.9% solids content and an IV of 0.74. This polymer concentrate was then diluted with additional ethyl acetate to a 5.0% solids primer coating solution.

### Example E1 and Comparative Examples CE1-CE2

Samples of Adhesive-1 were prepared. CE1 and CE2 were prepared by coating the adhesive on Release Liner-1. For Example E1, APA-1 was coated on the Release Liner-1 and then Adhesive-1 was coated over the APA-1 coating. On all samples, Release Liner-2 was coated on the exposed surface of Adhesive-1.

The samples were tested for Peel Adhesion against glass substrate. For sample CE-1 Adhesive-1 was used, for sample CE-2 Adhesive-1 was used and the glass substrate was treated with APA. The data are presented in Table 1.

TABLE 1

| | | Peel after 20 minute | Peel after 3 Day |
|---|---|---|---|
| Example | Description | dwell (N/cm) | dwell (N/cm) |
| CE-1 | No primer | 8 | 11 |
| CE-2 | Glass Substrate | 20 | 22 |
| | Primed | | |
| E-1 | Adhesive Layer | 16 | 18 |
| | with Primer | | |

### Example E2 and Comparative Examples CE3

Samples of Adhesive-2 were prepared. CE3 were prepared by coating the adhesive on Release Liner-1. For Example E2, APA-2 was coated on Release Liner-1 and then Adhesive-1 was coated over the APA-2 coating. On all samples, Release Liner-2 was coated on the exposed surface of Adhesive-2.

The samples were tested for Peel Adhesion against glass substrate. For sample CE-3 Adhesive-2 was used. The data are presented in Table 2.

TABLE 2

| | | Peel after 20 minute | Peel after 3 Day |
|---|---|---|---|
| Example | Description | dwell (N/cm) | dwell (N/cm) |
| CE-3 | Adhesive-2 | 6 | 8 |
| | Layer with No | | |
| | primer | | |
| E-2 | Adhesive-2 | 11 | 12 |
| | Layer with | | |
| | Primer | | |

What is claimed is:

1. An adhesive article comprising:
a release liner with a first major surface and a second major surface, wherein at least the second major surface comprises a release surface;
an adhesion promotion layer with a first major surface and a second major surface, wherein the first major surface of the adhesion promotion layer is in contact with the second major surface of the release liner; and
an optically clear adhesive layer with a first major surface and a second major surface, wherein the first major surface of the optically clear adhesive layer is in contact with the second major surface of the adhesion promotion layer, wherein the adhesion between the optically clear adhesive layer and the adhesion promotion layer is higher than the adhesion between the adhesion promotion layer and the release liner, such that adhesion promotion layer remains adhered to the surface of the optically clear adhesive layer upon removal of the optically clear adhesive layer from the release liner, and wherein the adhesion promotion layer is optically clear.

2. The adhesive article of claim 1, wherein the optically clear adhesive comprises a (meth)acrylate pressure sensitive adhesive, a (meth)acrylate-based pressure sensitive adhesive, a polyolefin pressure sensitive adhesive, a polyurethane pressure sensitive adhesive, a siloxane-based pressure sensitive adhesive, a polyvinyl butyral heat-activated adhesive, or a combination thereof.

3. The adhesive article of claim 1, wherein the adhesion promotion layer comprises polyamides, poly(meth)acrylates, chlorinated polyolefins, rubbers, chlorinated rubbers, polyurethanes, siloxanes, silanes, polyester, epoxies, polycarbodiimides, phenolics, and combinations thereof.

4. The adhesive article of claim 3, wherein the adhesion promotion layer comprises a (meth)acrylate-based primer.

5. The adhesive article of claim 1, wherein the adhesive article further comprises a substrate in contact with the second major surface of the optically clear pressure sensitive adhesive layer.

6. The adhesive article of claim 5, wherein the substrate comprises a release liner, a tape backing, or an optical film.

7. The adhesive article of claim 1, wherein the optically clear adhesive layer has a thickness of from 1 micrometer to 1 millimeter.

8. The adhesive article of claim 1, wherein the adhesion promotion layer is prepared by disposing on the second major surface of the release liner an adhesion promotion material as a solution, emulsion or dispersion and drying to remove the solvent.

9. The adhesive article of claim 1, wherein the adhesion promotion layer is prepared by disposing on the first major surface of the optically clear adhesive layer an adhesion promotion material as a solution, emulsion or dispersion and drying to remove the solvent.

10. The adhesive article of claim 1, wherein the adhesive article when the adhesion promotion layer surface is contacted to a substrate surface, the adhesion is greater than the adhesion of an identical article without the adhesion promotion layer.

11. A method of preparing an adhesive article comprising:
providing a release liner, wherein the release liner has a first major surface and a second major surface, and wherein at least the second major surface comprises a release surface;
providing an adhesion promotion composition;
disposing the adhesion promotion composition on the second major surface of the release liner to form an adhesion promotion layer on the second major surface of the release liner, wherein the adhesion promotion layer has a first major surface in contact with the release surface of the release liner, and a second major surface;
providing an optically clear adhesive or a precursor mixture capable of forming an optically clear adhesive;
disposing the optically clear adhesive or precursor mixture on the second major surface of the adhesion promotion layer, to form an optically clear adhesive layer, with a first major surface and a second major surface, wherein the first major surface of the optically clear adhesive layer is in contact with the second major surface of the adhesion promotion layer, wherein the adhesion between the optically clear adhesive layer and the adhesion promotion layer is higher than the adhesion between the adhesion promotion layer and the release liner, such that adhesion promotion layer remains adhered to the surface of the optically clear adhesive layer upon removal of the optically clear adhesive layer from the release liner.

12. The method of claim 11, wherein disposing the adhesion promotion composition on the second major surface of the release liner comprises coating a solution, emulsion or dispersion of an adhesion promoting material, and drying the coating.

13. The method of claim 12, wherein the adhesion promoting material comprises polyamides, poly(meth)acrylates, chlorinated polyolefins, rubbers, chlorinated rubbers, polyurethanes, siloxanes, silanes, polyester, epoxies, polycarbodiimides, phenolics, and combinations thereof.

14. The method of claim 11, wherein the optically clear adhesive or precursor mixture comprises an optically clear adhesive comprising a (meth)acrylate pressure sensitive adhesive, a (meth)acrylate-based pressure sensitive adhesive, a polyolefin pressure sensitive adhesive, a polyurethane pressure sensitive adhesive, a siloxane-based pressure sensitive adhesive, a polyvinyl butyral heat-activated adhesive, or a combination thereof.

15. The method of claim 11, wherein the optically clear pressure sensitive adhesive or precursor mixture comprises a precursor mixture of a coatable (meth)acrylate-based syrup and a photoinitiator, and after disposing the coatable (meth)acrylate syrup on the second surface of the release liner, the precursor mixture is irradiated to cure.

16. The method of claim 11, further comprising disposing a substrate on the second major surface of the optically clear pressure sensitive adhesive layer.

17. The method of claim 16, wherein the substrate comprises a release liner, a tape backing, or an optical film.

18. The method of claim 11, wherein the optically clear adhesive layer has a thickness of 1 micrometer to 1 millimeter.

19. The method of claim 11, further comprising removing the optically clear pressure sensitive adhesive layer with at least a portion of the adhesion promotion layer disposed on its surface is removed from the release liner and contacted to the surface of a substrate, such that the adhesion of the adhesive article is greater than the adhesion of an identical article without the adhesion promotion layer.

20. A method of preparing an adhesive article comprising:
providing a release liner, wherein the release liner has a first major surface and a second major surface, and wherein at least the second major surface comprises a release surface;
providing an adhesion promotion composition;
providing an optically clear adhesive layer with a first major surface and a second major surface;
disposing the adhesion promotion composition on the first major surface of the optically clear adhesive layer to form an adhesion promotion layer on the first major surface of the optically clear adhesive layer, wherein the adhesion promotion layer has a second major surface in contact with the first major surface of the optically clear adhesive layer, and an exposed first major surface;
disposing the optically clear adhesive layer with the adhesion promotion layer on the release surface of the release liner such that the first major surface of the adhesion promotion layer is in contact with the release surface of the release liner, wherein the adhesion between the optically clear adhesive layer and the adhesion promotion layer is higher than the adhesion between the adhesion promotion layer and the release liner, such that adhesion promotion layer remains adhered to the surface of the optically clear adhesive layer upon removal of the optically clear adhesive layer from the release liner.
